(19) United States
(12) Patent Application Publication
(10) Pub. No.: US 2024/0396912 A1
(43) Pub. Date: Nov. 28, 2024

(54) METHOD AND SYSTEM FOR NETWORK INTRUSION DETECTION IN INTERNET OF BLENDED ENVIRONMENT USING HETEROGENEOUS AUTOENCODER

(71) Applicant: AJOU UNIVERSITY INDUSTRY-ACADEMIC COOPERATION FOUNDATION, Suwon-si (KR)

(72) Inventors: Jin KWAK, Gyeonggi-do (KR); Deukhun KIM, Gyeonggi-do (KR); Lelisa Adeba JILCA, Gyeonggi-do (KR); Insu JUNG, Gyeonggi-do (KR)

(73) Assignee: AJOU UNIVERSITY INDUSTRY-ACADEMIC COOPERATION FOUNDATION, Suwon-si (KR)

(21) Appl. No.: 18/672,516

(22) Filed: May 23, 2024

(30) Foreign Application Priority Data
May 23, 2023 (KR) 10-2023-0066016

(51) Int. Cl. H04L 9/40

(52) U.S. Cl. CPC H04L 63/1425; H04L 63/1416

(57) ABSTRACT

A network intrusion detection system includes: a data collection unit configured to obtain a dataset for training a plurality of machine learning-based heterogeneous models included in the network intrusion detection system; a clustering module configured to cluster data points included in the obtained dataset; a routing module configured to selectively input the data points into at least one of the plurality of models based on a result of the clustering; and a model training unit configured to define a loss function based on a reconstruction loss of each of the at least one model for an input data point, and perform an update of each of the at least one model so that the defined loss function is minimized, wherein the model training unit sets an anomaly threshold for each of the at least one model based on loss distribution of reconstruction losses for the data points.

### CROSS-REFERENCE TO RELATED APPLICATION

This application claims the benefit of Korean Patent Application No. 10-2023-0066016, filed on May 23, 2023, in the Korean Intellectual Property Office, the disclosure of which is incorporated herein in its entirety by reference.

### BACKGROUND

### 1. Field

One or more embodiments relate to a method and system for detecting network intrusion, and more particularly, to a method of detecting network intrusion in Internet of Blended Environment (IoBE), an environment in which IoT devices are connected to each other to form a convergence environment such as a smart factory or smart healthcare, and these convergence environments are complexly interconnected, using a heterogeneous autoencoder.

Example embodiments of the present disclosure relate to two national research and development projects. Information on one national research and development project has subject identification No. 1711193576, subject No. RS-2021-11211806, project name “International joint research on information, communication and broadcasting technology (BIZ2023201BIZ2023202BIZ2023267)”, and subject title “Development of security by design and security management technology in smart factory”. Information on the other national research and development project has subject identification No. 1711192072, subject No. 2021R1A2C2011391, project name “Individual Basic Research (Ministry of Science and ICT) (R1A2C2)”, and subject title “Development of SOAR-CUBE Technology for Blended Threat in IoBE”.

### 2. Description of the Related Art

With recent developments in IT technology, the pace of development of new technologies and platforms is rapidly increasing, with the emergence of massive Internet of Things (IoT), which goes beyond simple IoT and connects all devices in daily life at high density through networks. In addition, convergence environments where various IoT devices are integrated, such as smart factories and smart healthcare, have emerged, and these convergence environments are also complexly connected to each other through various networks. Terms such as IoBE are used to represent an environment in which these convergence environments are complexly connected to each other.

As described above, when various convergence environments are converged (become a convergence environment) through a network, areas where security threats may occur may vary due to the hyper-connectivity of devices that make up the convergence environment. Accordingly, it is inevitable that security incidents will rapidly increase as an attack surface where cyber attacks may occur increases, so a method capable of effectively detecting various and complex security threats in IoBE is required.

### SUMMARY

One or more embodiments include a method and system capable of more accurately detecting network intrusion in IoBE where various convergence environments are complexly connected to each other.

Additional aspects will be set forth in part in the description which follows and, in part, will be apparent from the description, or may be learned by practice of the presented embodiments of the disclosure.

According to an aspect of an embodiment, a network intrusion detection system comprising: a data collection unit configured to obtain a dataset for training a plurality of machine learning-based heterogeneous models included in the network intrusion detection system; a clustering module configured to cluster data points included in the obtained dataset; a routing module configured to selectively input the data points into at least one of the plurality of models based on a result of the clustering; and a model training unit configured to define a loss function based on a reconstruction loss of each of the at least one model for an input data point, and perform an update of each of the at least one model so that the defined loss function is minimized, wherein the model training unit sets an anomaly threshold for each of the at least one model based on loss distribution of reconstruction losses for the data points.

According to an exemplary embodiment, the plurality of heterogeneous models comprise a first model and a second model, the clustering module classifies the data points into at least one of a first group and a second group, and the routing module inputs a data point included in the first group into the first model, inputs a data point included in the second group into the second model, and inputs data points included in the first group and the second group into the first model and the second model, respectively.

According to an exemplary embodiment, the first model comprises a convolutional variational autoencoder (VAE), and the second model comprises a long short term memory (LSTM)-VAE.

According to an exemplary embodiment, the clustering module classifies the data points into at least one of the first group and the second group using a Spatiotemporal Density-Based Spatial Clustering of Applications with Noise (ST-DBSCAN) algorithm, wherein the first group has relatively large spatial characteristics compared to the second group.

According to an exemplary embodiment, the model training unit is configured to: set a first anomaly threshold for the first model based on loss distribution of the first model for data points included in the first group; and set a second anomaly threshold for the second model based on loss distribution of the second model for data points included in the second group.

According to an exemplary embodiment, the network intrusion detection system further comprising: a network intrusion detection unit configured to detect network intrusion based on a data point input into at least one of the first model and the second model, wherein the network intrusion detection unit compares a reconstruction loss output from the at least one model into which the data point is input with an anomaly threshold set for the at least one model, and determines whether the data point includes abnormal data corresponding to network intrusion based on a result of the comparing.

According to an exemplary embodiment, the network intrusion detection unit determines that the data point includes the abnormal data when the reconstruction loss exceeds the set anomaly threshold.

According to an exemplary embodiment, the network intrusion detection unit is configured to: compare a reconstruction loss output from the first model with the first anomaly threshold when the data point is input to the first model by the routing module; compare a reconstruction loss output from the second model with the second anomaly threshold when the data point is input to the second model; and compare an average value of the respective reconstruction losses output from the first model and the second model with an average value of the first anomaly threshold and the second anomaly threshold when the data point is input into each of the first model and the second model.

According to an aspect of an embodiment, a network intrusion detection system comprising: a data collection unit configured to obtain a dataset of a network system connected to the network intrusion detection system; a clustering module configured to cluster a data point included in the obtained dataset; a routing module configured to selectively input the data point into at least one of a plurality of machine learning-based heterogeneous models based on a result of the clustering; and a network intrusion detection unit configured to detect network intrusion into the network system based on a reconstruction loss output from the at least one model into which the data point is input.

According to an aspect of an embodiment, a network intrusion detection system connected to a network system comprising: a data collection unit configured to obtain a dataset; a model training unit configured to set an optimal threshold for determining network intrusion based on loss distribution output from each of a plurality of machine learning-based heterogeneous models into which the obtained dataset is input; and a network intrusion detection unit configured to detect network intrusion into the network system based on an optimal threshold set by the model training unit and a final loss output from each of the plurality of heterogeneous models.

According to an exemplary embodiment, the model training unit is configured to: calculate anomaly thresholds based on the loss distribution output from each of the plurality of heterogeneous models, respectively; and set a maximum value of the calculated anomaly thresholds as the optimal threshold.

According to an exemplary embodiment, the network intrusion detection unit is configured to: compare a minimum value of the final losses of the plurality of heterogeneous models with the optimal threshold; and determine that a dataset input to the plurality of heterogeneous models includes abnormal data related to network intrusion when the minimum value exceeds the optimal threshold.

### BRIEF DESCRIPTION OF THE DRAWINGS

Embodiments of the disclosure will be more clearly understood from the following detailed description taken in conjunction with the accompanying drawings in which:

FIG. 1 is a schematic view of a system for detecting network intrusion from IoBE network traffic according to an embodiment;

FIG. 2 is a view for explaining an example of configuration and operation of a network intrusion detection system shown in FIG. 1;

FIGS. 3 and 4 are views showing examples of a first model and a second model shown in FIG. 2;

FIG. 5 is a view for explaining setting a threshold for detecting network intrusion according to an embodiment and an example of utilizing the set threshold;

FIG. 6 is a view for explaining another example of configuration and operation of the network intrusion detection system shown in FIG. 1;

FIG. 7 is a view for explaining a specific operation of the network intrusion detection system shown in FIG. 6;

FIG. 8 is a flowchart for explaining model training and a threshold setting process of the network intrusion detection system shown in FIG. 6;

FIG. 9 is a flowchart for explaining a network intrusion detection process of the network intrusion detection system shown in FIG. 6; and

FIG. 10 is a schematic block diagram of a device constituting a network intrusion detection system according to embodiments.

### DETAILED DESCRIPTION

Embodiments according to the inventive concept are provided to more completely explain the inventive concept to one of ordinary skill in the art, and the following embodiments may be modified in various other forms and the scope of the inventive concept is not limited to the following embodiments. Rather, these embodiments are provided so that the disclosure will be thorough and complete, and will fully convey the scope of the inventive concept to one of ordinary skill in the art.

It will be understood that, although the terms first, second, etc. may be used herein to describe various members, regions, layers, sections, and/or components, these members, regions, layers, sections, and/or components should not be limited by these terms. These terms do not denote any order, quantity, or importance, but rather are only used to distinguish one component, region, layer, and/or section from another component, region, layer, and/or section. Thus, a first member, component, region, layer, or section discussed below could be termed a second member, component, region, layer, or section without departing from the teachings of embodiments. For example, as long as within the scope of this disclosure, a first component may be named as a second component, and a second component may be named as a first component.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

The terms “unit”, “device”, “˜er (˜or)”, “module”, etc., refer to a processing unit of at least one function or operation, which may be implemented by hardware such as a processor, a microprocessor, an application processor, a micro controller, a central processing unit (CPU), an application processor (AP), a graphics processing unit (GPU), an accelerate processor unit (APU), a digital signal processor (DSP), an application specific integrated circuit (ASIC), a field programmable gate array (FPGA), a neural processing unit (NPU), a neuromorphic processor, etc., software, or a combination of hardware and software, and may be implemented in a form combined with a memory that stores data necessary for processing at least one function or operation.

Throughout the specification, components may be discriminated by their major functions. For example, two or more components as herein used may be combined into one, or a single component may be subdivided into two or more sub-components according to subdivided functions. Each of the components may perform its major function and further perform part or all of a function served by another component. In this way, part of a major function served by each component may be dedicated and performed by another component.

As used herein, the term “and/or” includes any and all combinations of one or more of the associated listed items.

Hereinafter, embodiments of the inventive concept will be described in detail with reference to the accompanying drawings.

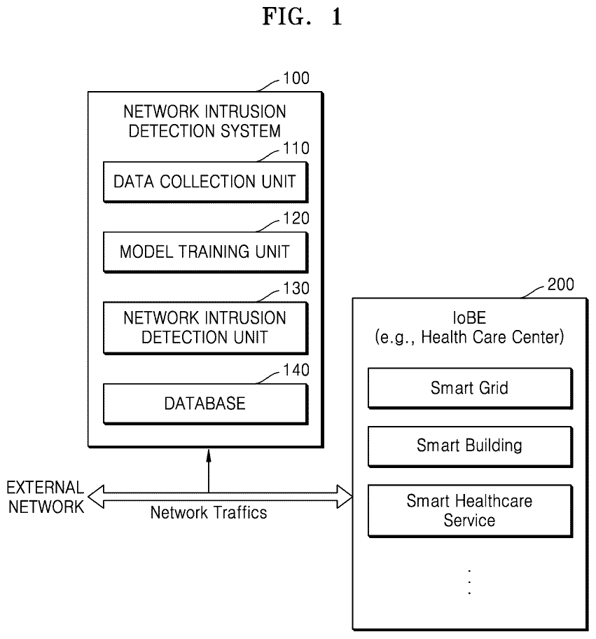

FIG. 1 is a schematic view of a system for detecting network intrusion from IoBE network traffic according to an embodiment.

With the recent development of IT technology, convergence environments that combine various IT technologies such as smart factories, smart buildings, and smart healthcare have emerged. These convergence environments are implemented individually, but because devices constituting each convergence environment may be connected to each other through a network, etc., the convergence environments may be complexly connected to each other. Terms such as Internet of Blended Environment (IoBE) are used to refer to an environment in which these convergence environments are complexly connected to each other.

As the convergence environments described above are complexly connected to each other, the number of devices included in IoBE increases rapidly, and the complexity of networks may increase as the types of networks connected to each device diversify. This means that attack surfaces where security threats may occur are also diversifying. A security threat that combines security vulnerabilities through these diversified attack surfaces is defined as a blended threat.

Referring to FIG. 1, a network intrusion detection system 100 is a system that detects network intrusion in IoBE 200 to effectively protect the IoBE 200 from convergence threats. In FIG. 1, a healthcare center is shown as an example of the IoBE 200. For example, a healthcare center may be implemented by connecting convergence environments such as a smart grid that manages power provided to facilities inside and outside a building, a smart building that performs general control and physical security of a building, and a smart healthcare service that provides IT-based healthcare services.

The network intrusion detection system 100 may include a data collection unit 110, a model training unit 120, a network intrusion detection unit 130, and a database 140, but may include more or fewer components according to an embodiment.

The network intrusion detection system 100 may be implemented with at least one computing device (server, etc.), and each component 110, 120, 130, and 140 shown in FIG. 1 may be implemented integrated or distributed in the at least one computing device.

The data collection unit 110 corresponds to a component that collects network traffic related to the IoBE 200. The network traffic may include network traffic transmitted from the outside to various convergence environments and devices within the IoBE 200, but according to an embodiment, may also include network traffic transmitted from devices included in the IoBE 200 to the outside. In FIG. 1, the network intrusion detection system 100 is shown as obtaining and analyzing network traffic between an external network and the IoBE 200. However, the network intrusion detection system 100 may be configured inside the IoBE 200 to analyze traffic transmitted and received to and from an external network.

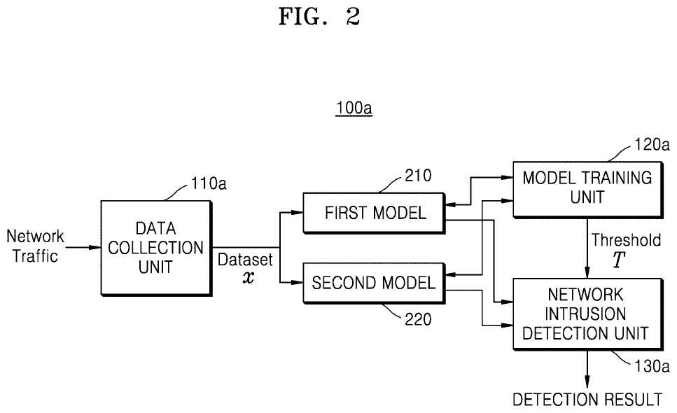

The model training unit 120 corresponds to a configuration for training a machine learning model that detects network intrusion in the IoBE 200, and the network intrusion detection unit 130 is a component that detects network intrusion from the network traffic using a trained machine learning model. Embodiments of the model training unit 120 and the network intrusion detection unit 130 will be described in more detail later with reference to FIGS. 2 to 9.

The database 140 may store various data related to a configuration and operation of the network intrusion detection system 100, such as the network traffic described above or data (log data, etc.) obtained through processing of network traffic, data related to the machine learning model, and an instruction or algorithm related to model training and/or network intrusion detection.

Hereinafter, various embodiments of a method of detecting network intrusion in the IoBE 200 by the network intrusion detection system 100 will be described through FIGS. 2 to 9.

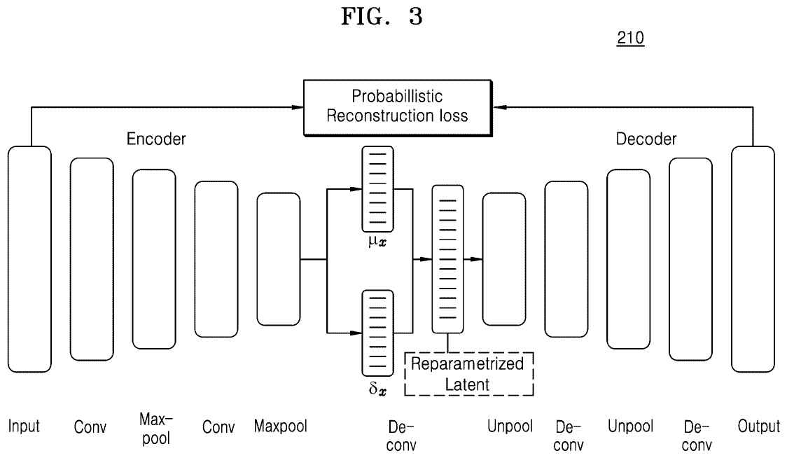

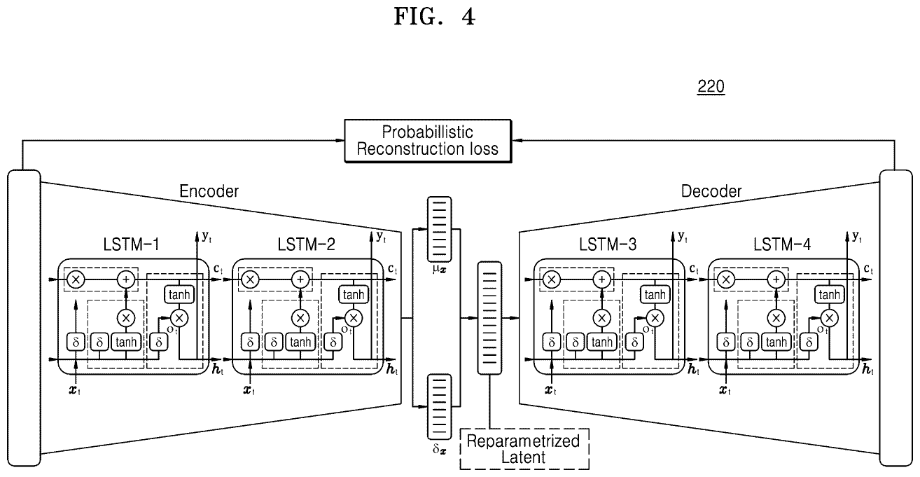

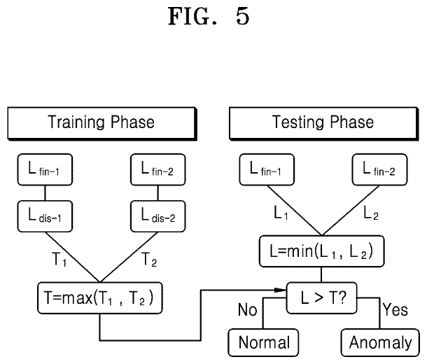

FIG. 2 is a view for explaining an example of configuration and operation of the network intrusion detection system shown in FIG. 1. FIGS. 3 and 4 are views showing examples of a first model and a second model shown in FIG. 2. FIG. 5 is a view for explaining setting a threshold for detecting network intrusion according to an embodiment and an example of utilizing the set threshold.

Referring to FIG. 2, a network intrusion detection system 100a may collect a dataset from network traffic of the IoBE 200 and detect whether the collected dataset includes data related to network intrusion (hereinafter defined as ‘abnormal data’). For example, the abnormal data may include attack data (malware, etc.) for network intrusion.

In more detail, a data collection unit 110a may obtain dataset x from the network traffic. For example, the data collection unit 110a may obtain dataset x by capturing packets included in network traffic and extracting certain characteristics (time stamp, source IP address, destination IP address, service protocol, port number, etc.) included in the packets through filtering and/or parsing the captured packets. For example, the data collection unit 110a may obtain the dataset x using a network analysis framework such as Zeek, but the disclosure is not limited thereto. The obtained dataset x may include at least one data point, and the data point may refer to single network traffic including certain characteristics described above. According to an embodiment, in a training phase, a dataset already generated for training may be provided. The data collection unit 110a may process the dataset x into a form for input to models 210 and 220 through numericalization, transformation, encoding, or normalization according to a certain algorithm.

In a training phase of the first model 210 and the second model 220, the processed dataset x may correspond to a training dataset, and in a detection phase or test phase, the dataset x may correspond to an actual dataset of the IoBE 200 or a test dataset. The dataset x provided in the training phase may include only normal data that does not correspond to network intrusion. That is, because the first model 210 and the second model 220 are trained based on normal data, the first model 210 and the second model 220 will not be able to accurately restore abnormal data related to network intrusion. When the data cannot be restored accurately, a reconstruction loss value may be relatively large. The network intrusion detection system 100 may infer that the dataset includes abnormal data when the reconstruction loss value exceeds a preset threshold.

The collected dataset x may be input into each of a plurality of models included in the network intrusion detection system 100a. Although two models 210 and 220 are shown in FIG. 2, the present embodiment is not limited thereto, and the number of models may vary. The plurality of models may correspond to different types of (heterogeneous) machine learning models.

In order to mitigate convergence threats in an IoBE 200 environment, an intrusion detection method suitable for the IoBE 200 environment may be required. In the case of IoBE 200, it is necessary to consider spatial characteristics of network traffic due to the diversity of attack surfaces, and temporal characteristics such as duration, time patterns, time delays, timing of occurrence, etc. of cyber attacks need to be considered. To this end, the first model 210 according to an embodiment may be implemented as a convolution-based model for learning spatial characteristics, and the second model 220 may be implemented as a long short term memory (LSTM)-based model for learning temporal characteristics.

In addition, the models 210 and 220 according to an embodiment are models for effectively distinguishing data (abnormal data) related to network intrusion from normal data and may be implemented as a variational autoencoder (VAE). The VAE is a variation of autoencoder that learns latent representations of data using stochastic latent variables. While a typical autoencoder focuses on simply reconstructing input and output, the VAE has the advantage of being able to model various representations of data in a latent space by sampling latent variables using probability distributions, so the VAE may be more suitable for the detection of cyberattacks.

Based on this, referring to FIGS. 3 and 4, the first model 210 may be implemented as a convolutional VAE, and the second model 220 may be implemented as LSTM-VAE.

The VAE generally includes an encoder, a latent variable (latent space), and a decoder, and each of an encoder and decoder of the first model 210 includes a convolution layer (or a transposed convolutional layer) and a pooling layer (or an unpooling layer), so that it is possible to learn a latent representation of data considering spatial characteristics. On the other hand, because each of an encoder and decoder of the second model 220 includes an LSTM layer, it is possible to learn a latent representation of data considering temporal characteristics.

First, referring to FIG. 3, the encoder of the first model 210 extracts features of the input dataset x through a convolution layer and summarizes information by reducing the spatial size through a pooling layer, thereby compressing the input dataset x into a low-dimensional latent representation. An output of the encoder may include a mean vector μₓ and a variance vector δₓ that parameterize the probability distribution of a latent variable.

The first model 210 may sample a latent variable (latent space) using the mean vector μₓ and the variance vector δₓ, and the decoder may reconstruct the dataset through a transposed convolutional layer and an unpooling layer for the sampled latent variable. An output of the decoder may correspond to the reconstructed dataset.

When the reconstructed dataset is output, the first model 210 may define a loss function including a difference (reconstruction error) between the input dataset x and the reconstructed dataset and a KL divergence. For example, the loss function may use a mean square error. The model training unit 120a may update weights and biases of the first model 210 using a backpropagation algorithm and gradient descent to minimize the loss function.

Referring to FIG. 4, the encoder of the second model 220 may pass the input dataset x through an LSTM layer and output the mean vector μₓ and the variance vector δₓ that parameterize probability distribution of a latent variable by considering a current input and previous state. The second model 220 may sample a latent variable (latent space) using the mean vector μₓ and the variance vector δₓ. The sampled latent variable may correspond to a low-dimensional expression that compresses the characteristics of time series data.

The decoder of the second model 220 may reconstruct the dataset by receiving a latent variable and previous output as an input and passing them through the LSTM layer. When the reconstructed dataset is output, the second model 220 may define a loss function including a difference (reconstruction error) between the input dataset x and the reconstructed dataset and a KL divergence. The model training unit 120a may update weights and biases of the second model 220 using a backpropagation algorithm and gradient descent to minimize the loss function.

Referring to FIG. 5, the model training unit 120a may set an optimal threshold T for determining network intrusion based on loss distribution of the first model 210 and the second model 220. First, the model training unit 120a may calculate an anomaly threshold T₁ of the first model 210 based on loss distribution L_{dis-1} of the first model 210, and may calculate an anomaly threshold T₂ of the second model 220 based on loss distribution L_{dis-2} of the second model 220. The model training unit 120a may set a maximum value of the calculated anomaly thresholds T₁ and T₂ as the optimal threshold T.

In a detection phase (or test phase), when the dataset x is input to each of the trained first model 210 and second model 220, final losses L_{fin-1} and L_{fin-2} for the input dataset x may be output from the first model 210 and the second model 220, respectively. The final losses L_{fin-1} and L_{fin-2} may correspond to a combination of a reconstruction loss and KL divergence.

A network intrusion detection unit 130a may infer whether the dataset x includes abnormal data by comparing a minimum value L of a final loss L₁ of the first model 210 and a final loss L₂ of the second model 220 with the optimal threshold T, and output a network intrusion detection result based on an inference result. For example, when the minimum value L is greater than the optimal threshold T, the network intrusion detection unit 130a may infer that the dataset x includes abnormal data and output a detection result corresponding to a network intrusion. On the other hand, when the minimum value L is less than the optimal threshold T, the network intrusion detection unit 130a may infer that the dataset x does not include abnormal data and output a detection result corresponding to network non-intrusion.

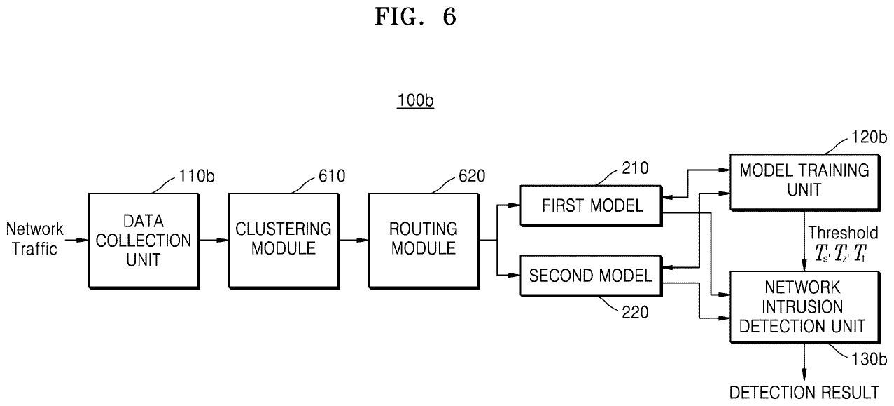

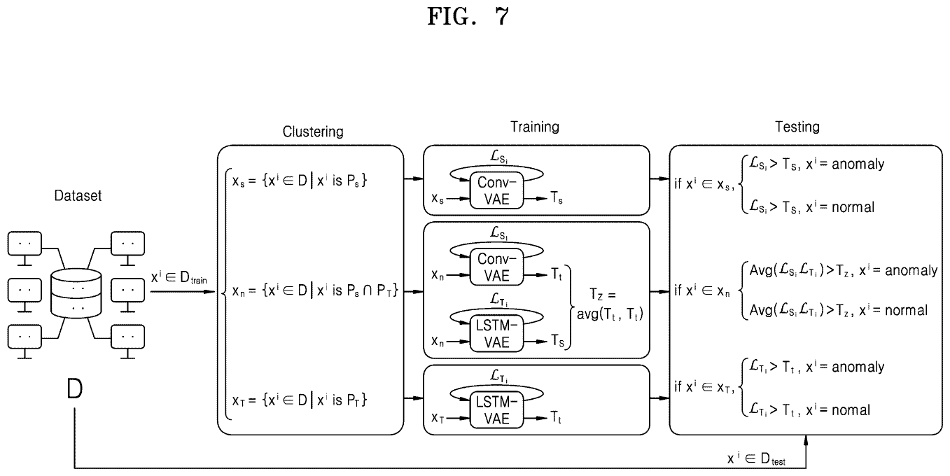

FIG. 6 is a view for explaining another example of configuration and operation of the network intrusion detection system shown in FIG. 1. FIG. 7 is a view for explaining a specific operation of the network intrusion detection system shown in FIG. 6.

Referring to FIG. 6, a network intrusion detection system 100b may be configured to further include a clustering module 610 and a routing module 620 in addition to the configuration of the network intrusion detection system 100a shown in FIGS. 2 to 5.

The clustering module 610 may classify (cluster) a dataset provided from a data collection unit 110b into a plurality of predefined groups. When the first model 210 and the second model 220 included in the network intrusion detection system 100b correspond to Convolutional VAE and LSTM-VAE, respectively, the clustering module 610 may classify data points xⁱ (i is a natural number) included in the dataset into a first group and a second group according to temporal and spatial interdependency. As described above in FIG. 2, data points included in the dataset may represent single network traffic including certain characteristics (time stamp, source IP address, destination IP address, service protocol, port number, etc.).

For example, the clustering module 610 may classify data points using an ST-DBSCAN (Spatiotemporal Density-Based Spatial Clustering of Applications with Noise) algorithm, but the disclosure is not limited thereto. When the data points included in the dataset are classified into the first group and the second group according to the ST-DBSCAN algorithm, one group (e.g., the first group) may have relatively high spatial characteristics (spatial interdependence), and the other group (e.g., the second group) may have relatively high temporal characteristics.

The routing module 620 may selectively input a data point xⁱ into at least one of the first model 210 and the second model 220 based on a clustering result. In more detail, the routing module 620 may route the data point xⁱ to the first model 210 when the data point xⁱ is a data point xₛ belonging to the first group, and may route the data point xⁱ to the second model 220 when the data point xⁱ is a data point XT belonging to the second group. According to an embodiment, any data point that has both spatial and temporal characteristics may be included in each of the first and second groups. When the data point xⁱ is a data point xₙ included in each of the first and second groups, the routing module 620 may simultaneously consider the results of the two models by routing the data point xⁱ to the first model 210 and the second model 220, respectively.

In a training phase, a model training unit 120b may define a loss function based on reconstruction losses [symbol] ₛ_{ᵢ} and [symbol] _{T}_{ᵢ}, and a KL divergence when inputting the data point xⁱ for each of the first model 210 and the second model 220, and update the weight or bias of each of the models so that the loss function is minimized using a backpropagation algorithm.

The model training unit 120b may set optimal loss values (Stochastic reconstruction losses; [symbol] ₛ and [symbol] _{T}) for each of the first model 210 and the second model 220 based on the reconstruction losses [symbol] ₛ_{ᵢ} and [symbol] _{T}_{ᵢ} when inputting data point xⁱ, and set anomaly thresholds Tₛ, Tₜ, and T_{z} based on loss distribution. As described above, the anomaly threshold Tₛ of the first model 210 and the anomaly threshold Tₜ of the second model 220 may be calculated using a Z-score of 95%, but the disclosure is not limited thereto.

The anomaly threshold T_{z} when data point xⁱ is routed to each of the first model 210 and the second model 220 may be set as an average value of the anomaly threshold Tₛ of the first model 210 and the anomaly threshold Tₜ of the second model 220, but the disclosure is not limited thereto. The model training unit 120b may provide the set anomaly thresholds Tₛ, Tₜ, and T_{z} to a network intrusion detection unit 130b.

In a detection phase (test phase), when data point xⁱ is selectively input by the routing module 620 into at least one of the first model 210 and the second model 220, the model 210 and/or 220 to which data point xⁱ is input may output the stochastic reconstruction losses [symbol] ₛ_{ᵢ} and/or [symbol] _{T}_{ᵢ} for data point xⁱ.

When the stochastic reconstruction loss [symbol] ₛ_{ᵢ} is output only from the first model 210 and exceeds the anomaly threshold Tₛ of the first model 210, the network intrusion detection unit 130b may determine that data point xⁱ is abnormal data and detect that network intrusion has occurred.

Similarly, when the stochastic reconstruction loss [symbol] _{T}_{ᵢ} is output only from the second model 220 and exceeds the anomaly threshold Tₜ of the second model 220, the network intrusion detection unit 130b may determine that data point xⁱ is abnormal data and detect that network intrusion has occurred.

Furthermore, when the stochastic reconstruction losses [symbol] ₛ_{ᵢ} and [symbol] _{T}_{ᵢ} are output from the first model 210 and the second model 220 and an average value of the stochastic reconstruction losses [symbol] ₛ_{ᵢ} and [symbol] _{T}_{ᵢ} exceeds the anomaly threshold T_{z}, the network intrusion detection unit 130b may determine that data point xⁱ is abnormal data and detect that network intrusion has occurred.

According to this example, because the network intrusion detection system 100b may perform efficient training and intrusion detection by selecting an appropriate model from a plurality of models according to the characteristics (temporal interdependence and spatial interdependence) of a data point, the network intrusion detection system 100b may reduce a processing load in a training and intrusion detection process and improve processing speed.

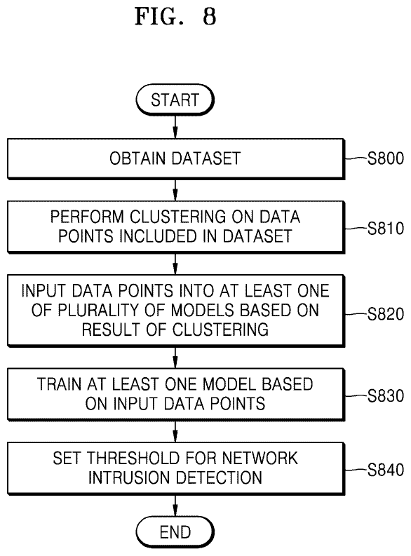

FIG. 8 is a flowchart for explaining model training and a threshold setting process of the network intrusion detection system shown in FIG. 6.

Referring to FIG. 8, in operation S800, the network intrusion detection system 100b may obtain a dataset for training a plurality of models.

The obtained dataset may be a training dataset processed for training a plurality of models, but the disclosure is not limited thereto. The obtained dataset may include normal data not related to network intrusion and may not include abnormal data related to network intrusion.

In operation S810, the network intrusion detection system 100b may perform clustering on data points included in the dataset. As described above, when the network intrusion detection system 100b includes the convolutional VAE 210 and the LSTM-VAE 220, the network intrusion detection system 100b may cluster data points into a first group and a second group.

The network intrusion detection system 100b, in operation S820, may selectively input data points into at least one of the plurality of models 210 and 220 based on a clustering result, and in operation S830, may train at least one model based on the input data points. In operation S840, based on a training result, the network intrusion detection system 100b may set a threshold (anomaly threshold) for network intrusion detection for each model. According to an embodiment, when a data point is input into each of the first model 210 and the second model 220, the anomaly threshold may correspond to an average value of an anomaly threshold of the first model 210 and an anomaly threshold of the second model 220.

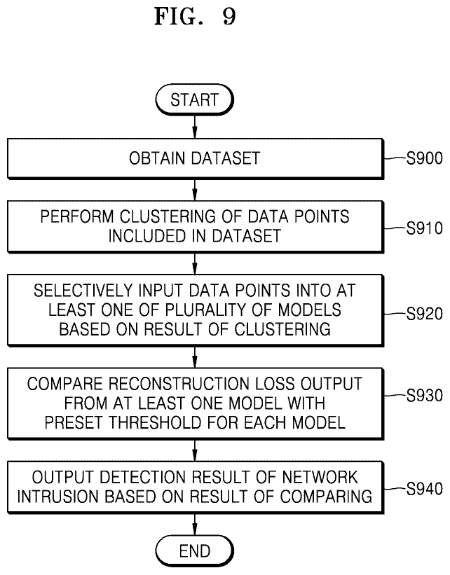

FIG. 9 is a flowchart for explaining a network intrusion detection process of the network intrusion detection system shown in FIG. 6.

Referring to FIG. 9, in operation S900, the network intrusion detection system 100b may obtain a dataset to detect network intrusion in the IoBE 200.

The network intrusion detection system 100b may obtain the dataset through preprocessing of network traffic transmitted from an external network to the IoBE 200.

In operation S910, the network intrusion detection system 100b may perform clustering of data points included in the obtained dataset, and may selectively input the data points into at least one of the plurality of models 210 and 220 based on a clustering result in operation S920.

In operation S930, the network intrusion detection system 100b may compare a reconstruction loss (stochastic reconstruction loss) output from at least one model into which the data points are input with a preset threshold (anomaly threshold) for each model. According to an embodiment, when the data points are input into each of the first model 210 and the second model 220, the network intrusion detection system 100b may compare an average value of respective reconstruction losses output from the models 210 and 220 with an average value of the anomaly threshold of the first model 210 and the anomaly threshold of the second model 220.

In operation S940, the network intrusion detection system 100b may output a detection result of network intrusion in the IoBE 200 based on a result of the comparing.

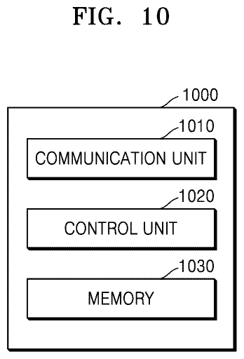

FIG. 10 is a schematic block diagram of a device constituting a network intrusion detection system according to embodiments.

Referring to FIG. 10, a device 1000 according to an embodiment may correspond to any one of at least one computing device constituting the network intrusion detection system 100 described above with reference to FIGS. 1 to 9. In this case, the device 1000 may correspond to a device that performs at least some of the processes described above in this specification, such as data collection/preprocessing, clustering of data points included in a dataset, routing, model training, and network intrusion detection.

The device 1000 may include a communication unit 1010, a control unit 1020, and a memory 1030. However, components of the device 1000 are not limited to the examples described above. For example, the device 1000 may include more or fewer components than the components described above.

The communication unit 1010 is a component for connecting the device 1000 to other devices included in the network intrusion detection system 100, the IoBE 200, an external network, etc., and may include various known wired/wireless communication interfaces.

The control unit 1020 is a component that controls all operations of the device 1000 and may perform control and processing operations to perform at least some of the processes described above. The control unit 1020 may include at least one processor, and the at least one processor may include hardware such as a central processing unit (CPU), an application processor (AP), an integrated circuit, a microcomputer, an application specific integrated circuit (ASIC), a field programmable gate array (FPGA), and/or a neural processing unit (NPU).

The memory 1030 may store programs and data necessary for the operation of the device 1000. In addition, the memory 1030 may store at least one of data generated or obtained through the control unit 1020. According to an embodiment, the memory 1030 may be understood as a concept including the database 140.

The memory 1030 may be composed of a storage medium such as ROM, RAM, flash memory, SSD, or HDD, or a combination of storage media.

According to the inventive concept, a network intrusion detection system detects network intrusions by considering the temporal and spatial characteristics of a dataset, thereby improving the security of an IoBE environment by improving detection accuracy in the IoBE environment with diverse attack surfaces.

In addition, because the network intrusion detection system may perform efficient training and intrusion detection by selecting an appropriate model from among multiple machine training models according to the characteristics (temporal interdependence and spatial interdependence) of a dataset, the network intrusion detection system may reduce a processing load in a training and intrusion detection process and improve processing speed.

Effects obtainable by the inventive concept are not limited to the effects described above, and other effects not described herein may be clearly understood by one of ordinary skill in the art to which the disclosure belongs from the above description.

While the disclosure has been particularly shown and described with reference to embodiments thereof, it will be understood that various changes in form and details may be made therein without departing from the spirit and scope of the following claims.

In addition, it will be apparent to one of ordinary skill in the art that various changes and modifications are possible within a range that does not deviate from the basic principles of the disclosure. While the disclosure has been particularly shown and described with reference to embodiments thereof, it will be understood that various changes in form and details may be made therein without departing from the spirit and scope of the following claims.

In addition, it will be apparent to one of ordinary skill in the art that various changes and modifications are possible within a range that does not deviate from the basic principles of the disclosure.

What is claimed is:

1. A network intrusion detection system comprising:
a data collection unit configured to obtain a dataset for training a plurality of machine learning-based heterogeneous models included in the network intrusion detection system;
a clustering module configured to cluster data points included in the obtained dataset;
a routing module configured to selectively input the data points into at least one of the plurality of models based on a result of the clustering; and
a model training unit configured to define a loss function based on a reconstruction loss of each of the at least one model for an input data point, and perform an update of each of the at least one model so that the defined loss function is minimized,
wherein the model training unit sets an anomaly threshold for each of the at least one model based on loss distribution of reconstruction losses for the data points.

2. The network intrusion detection system of claim 1, wherein the plurality of heterogeneous models comprise a first model and a second model,
the clustering module classifies the data points into at least one of a first group and a second group, and
the routing module inputs a data point included in the first group into the first model, inputs a data point included in the second group into the second model, and inputs data points included in the first group and the second group into the first model and the second model, respectively.

3. The network intrusion detection system of claim 2, wherein the first model comprises a convolutional variational autoencoder (VAE), and the second model comprises a long short term memory (LSTM)-VAE.

4. The network intrusion detection system of claim 3, wherein the clustering module classifies the data points into at least one of the first group and the second group using a Spatiotemporal Density-Based Spatial Clustering of Applications with Noise (ST-DBSCAN) algorithm,
wherein the first group has relatively large spatial characteristics compared to the second group.

5. The network intrusion detection system of claim 4, wherein the model training unit is configured to:
set a first anomaly threshold for the first model based on loss distribution of the first model for data points included in the first group; and
set a second anomaly threshold for the second model based on loss distribution of the second model for data points included in the second group.

6. The network intrusion detection system of claim 5, further comprising:
a network intrusion detection unit configured to detect network intrusion based on a data point input into at least one of the first model and the second model,
wherein the network intrusion detection unit compares a reconstruction loss output from the at least one model into which the data point is input with an anomaly threshold set for the at least one model, and
determines whether the data point includes abnormal data corresponding to network intrusion based on a result of the comparing.

7. The network intrusion detection system of claim 6, wherein the network intrusion detection unit determines that the data point includes the abnormal data when the reconstruction loss exceeds the set anomaly threshold.

8. The network intrusion detection system of claim 6, wherein the network intrusion detection unit is configured to:
compare a reconstruction loss output from the first model with the first anomaly threshold when the data point is input to the first model by the routing module;
compare a reconstruction loss output from the second model with the second anomaly threshold when the data point is input to the second model; and
compare an average value of the respective reconstruction losses output from the first model and the second model with an average value of the first anomaly threshold and the second anomaly threshold when the data point is input into each of the first model and the second model.

9. A network intrusion detection system comprising:
a data collection unit configured to obtain a dataset of a network system connected to the network intrusion detection system;
a clustering module configured to cluster a data point included in the obtained dataset;
a routing module configured to selectively input the data point into at least one of a plurality of machine learning-based heterogeneous models based on a result of the clustering; and
a network intrusion detection unit configured to detect network intrusion into the network system based on a reconstruction loss output from the at least one model into which the data point is input.

10. The network intrusion detection system of claim 9, wherein the plurality of heterogeneous models comprise a first model and a second model,
the clustering module classifies the data points into at least one of a first group and a second group, and
the routing module inputs a data point included in the first group into the first model, inputs a data point included in the second group into the second model, and inputs data points included in the first group and the second group into the first model and the second model, respectively.

11. The network intrusion detection system of claim 10, wherein the first model comprises a convolutional variational autoencoder (VAE), and the second model comprises a long short term memory (LSTM)-VAE.

12. The network intrusion detection system of claim 11, wherein the clustering module classifies the data points into at least one of the first group and the second group using a Spatiotemporal Density-Based Spatial Clustering of Applications with Noise (ST-DBSCAN) algorithm,
wherein the first group has relatively large spatial characteristics compared to the second group.

13. The network intrusion detection system of claim 10, wherein the network intrusion detection unit is configured to:
compare a reconstruction loss output from the at least one model into which the data point is input with an anomaly threshold set for the at least one model; and
determine whether the data point includes abnormal data corresponding to network intrusion based on a result of the comparing.

14. The network intrusion detection system of claim 13, wherein the network intrusion detection unit determines that the data point includes the abnormal data when the reconstruction loss exceeds the set anomaly threshold.

15. The network intrusion detection system of claim 13, wherein the network intrusion detection unit is configured to:
compare a reconstruction loss output from the first model with a first anomaly threshold set for the first model when the data point is input to the first model by the routing module;
compare a reconstruction loss output from the second model with the second anomaly threshold set for the second model when the data point is input to the second model; and
compare an average value of the respective reconstruction losses output from the first model and the second model with an average value of the first anomaly threshold and the second anomaly threshold when the data point is input into each of the first model and the second model.

16. A network intrusion detection system connected to a network system, the network intrusion detection system comprising:
a data collection unit configured to obtain a dataset;
a model training unit configured to set an optimal threshold for determining network intrusion based on loss distribution output from each of a plurality of machine learning-based heterogeneous models into which the obtained dataset is input; and
a network intrusion detection unit configured to detect network intrusion into the network system based on an optimal threshold set by the model training unit and a final loss output from each of the plurality of heterogeneous models.

17. The network intrusion detection system of claim 16, wherein the model training unit is configured to:
calculate anomaly thresholds based on the loss distribution output from each of the plurality of heterogeneous models, respectively; and
set a maximum value of the calculated anomaly thresholds as the optimal threshold.

18. The network intrusion detection system of claim 16, wherein the network intrusion detection unit is configured to:
compare a minimum value of the final losses of the plurality of heterogeneous models with the optimal threshold; and
determine that a dataset input to the plurality of heterogeneous models includes abnormal data related to network intrusion when the minimum value exceeds the optimal threshold.
